(19) United States
(12) Patent Application Publication
(10) Pub. No.: US 2023/0252371 A1
(43) Pub. Date: Aug. 10, 2023

(54) SYSTEM AND METHOD FOR AUTOMATED TRIP PLANNING

(71) Applicant: Cambridge Industrial Enterprises Limited, Oxford (GB)

(72) Inventors: Adam PARR, Oxford (GB); Diana MARKS, Oxford (GB)

(21) Appl. No.: 18/162,188

(22) Filed: Jan. 31, 2023

Related U.S. Application Data
(60) Provisional application No. 63/307,308, filed on Feb. 7, 2022.

(51) Int. Cl. G06Q 10/02; G06F 16/2455

(52) U.S. Cl. CPC G06Q 10/025; G06F 16/24564

(57) ABSTRACT

Methods and systems for generating a travel schedule are described. The travel schedule generation system includes a rules modeler, a profile modeler, and a schedule generator. The rules modeler receives a plurality of rules that govern a travel schedule and encodes the received plurality of rules as a first plurality of resource description framework (RDF) triples. The profile modeler receives information about one or more users and encodes the received information about the one or more users as a second plurality of RDF triples. The schedule generator generates a knowledge graph using the first plurality of RDF triples, generates a query using the second plurality of RDF triples, and generates the travel schedule by performing semantic reasoning on the knowledge graph using the query.

### TECHNICAL FIELD OF THE INVENTION

Aspects of this disclosure generally are related to systems and methods of automating planning and scheduling of travel trips using computing devices. More particularly, but not exclusively, the present invention relates to the modelling of traveler information and country specific travel rules and regulations as knowledge graphs, using symbolic reasoning to query the knowledge graph and generating a travel plan based on query results from the knowledge graph.

### CROSS REFERENCE TO RELATED APPLICATIONS

This application claims the priority benefit of U.S. Provisional Application No. 63/307,308 filed Feb. 7, 2022, the entire disclosure of which is hereby incorporated herein in its entirety by reference.

### BACKGROUND OF THE INVENTION

Travel planning generally involves determining one or more destinations, one or more modes of transportation, and routings from the origin to the one or more destinations. Travel planning, however, can be a complicated and cumbersome process involving a lot of choices and selections that may lead to inefficiencies. For instance, travelers often have many alternatives for routes, which may be incomplete or include difficult to obtain route information. Different travelers in a travel party may have different requirements or preferences. There may be a multitude of travel providers, using non-homogeneous data formats for schedule information, and different pricing schemes. Travel routings may not fully reflect loss of time from route congestion or intermodal transfers, which can vary non-uniformly. This often leads to choosing sub-optimal routes for the travel party.

COVID-19 completely upended conventional approaches to travel planning. Entry into a foreign country has traditionally been governed by visa requirements, which are determined by one factor: the nationality of a traveller. Travel planning in the post-COVID-19 world requires understanding entry and exit rules for each destination country as well as auxiliary requirements such as previous travel history, vaccination status, testing, isolation, and quarantine. These apply to travel to the home country as well as abroad. The entry and exit rules may vary based on the origin of travel, entry point, mode of transportation, age, nationality or residency of travelers, and previous travel destinations. Every country publishes rules for entering its territory using different rule structures, categories, terminology and definitions. Rules change as conditions change. This combination of attributes results in travel planning rules having four attributes—interdependence, complexity, variability and changeability.

While it is to be hoped that the worst of COVID-19 is behind us, it has exposed the extreme impact that travel restrictions can have on the global economy. It is essential that better systems are in place to mitigate against any future outbreaks of COVID-19, other diseases, and other global events that might require the United States and other countries to impose similar restrictions for security or health reasons. This involves providing travelers with the most accurate information possible so that they can travel confidently and in compliance with all applicable rules.

Today, travelers often use travel websites as their first source of information about different travel services. Travel websites also offer travel planning services based on their preferences. Travel websites generally require travelers to provide two discrete criteria: (1) a pair of travel terminals, which include airports, rail stations or bus stations; and (2) a date and time preference for departure from the origin terminal. Depending on the type of travel service provided by the travel website, the travelers are then provided feasible travel options between the origin and the destination using the travel routes serviced by the travel service. Where the travel includes foreign destinations, the travel websites can also provide information on visa and length of stay, based on the nationalities and residencies of the travelers in a party.

Recently, in an effort to account for COVID-19 travel restrictions, some of the travel websites provide information that tells travelers up to three facts based on a small amount of information (nationality and vaccination status): (a) can you travel (b) do you need a COVID-19 test and (c) what form(s) must you fill in. These sites are unable to provide complete and accurate information since they do not require travelers to provide dates and types of vaccination, or previous travel history. In addition, they cannot provide for travelers in family or other groups, nor for journeys involving more than one leg. Most family travel involves one or more children, in which case the group must be considered as a whole. In many cases, families may have parents with different passports (a US citizen married to a non-citizen, for example), in which case they must be considered together. Similar situations could arise in the future.

However, this information merely scratches the surface of the complex requirements that face an international traveler. Which vaccinations and tests are accepted by which country? Exactly when and how often must you have been vaccinated, where, and with which vaccine? When must you take a test, what type and how certified? If you have had the disease (such as COVID-19), does this change your status and how must it be proven? None of the websites can or do state that their information is more than guidance. All state that the traveler must verify the requirements themselves. That is because, even if the rules are kept up to date, they are not sophisticated enough to deal with the requirements even of a single traveller taking a single-destination trip. No existing system purports to offer multi-leg and/or group travel planning.

Further, the rules and regulations issued by each country evolve rapidly, as the incidence of disease outbreaks ebbs and flows in various parts of the world. An itinerary that works today may not work tomorrow because of rule changes. Thus, a travel planning system must be able to quickly adapt existing itineraries to account for the changing pandemic landscape.

Accordingly, there is a desire to provide a travel planning system able to manage the variable, complex, interdependent, and dynamic nature of the travel rules, which are not merely quantitatively but qualitatively beyond the capacity of any existing system. The present invention solves the problem by applying semantic reasoning, which combines rule-based intelligence with scale and complexity beyond human mental capacity and, crucially, a rule-based reasoning method which is transparent and therefore both manageable and auditable. The declarative and transitive nature of semantic reasoning means that it avoids the impossible task of hard coding each individual rule. The feature of incremental reasoning allows that any data point may be changed and the system automatically updates, for example, with the passage of time, adding a test result, or changing the itinerary or identity of the travel group. The feature of an ontology means the system allows travel rules to be updated simply by reference to the existing ontology. For example, if the US introduces a ‘red list’ of origin countries, then as the concept already exists in the ontology, there is a need only to state that the US has a red list, and to add (by drop-down menu) the countries on the list. The faceted search feature means the system can be easily audited, for example, querying ‘Which countries have a red list?’ This is crucial, as no system can be relied on if it cannot be audited.

### SUMMARY OF THE INVENTION

At least the above-discussed need is addressed and technical solutions are achieved in the art by various embodiments of the present invention. Travel rules and regulations may be modeled as a Resource Description Framework (RDF) triplestore to enable semantic reasoning and generate flexible and adaptive travel itineraries based on traveler and trip information.

According to a first embodiment of the invention there is provided a travel schedule generation system comprising at least one memory configured to a store a program and at least one processor communicatively connected to the at least one memory and configured to execute the stored program. In some embodiments, the travel schedule generation system may be configured to, via the stored program, to comprise a rules modeler, a profile modeler, and a schedule generator. In some embodiments, the rules modeler is configured to receive a plurality of rules that govern a travel schedule, and encode the received plurality of rules as a first plurality of resource description framework (RDF) triples; the profile modeler is configured to receive information about one or more users and encode the received information about the one or more users as a second plurality of RDF triples; and the schedule generator is configured to generate a knowledge graph using the first plurality of RDF triples, generate a query using the second plurality of RDF triples, and generate the travel schedule by performing semantic reasoning on the knowledge graph using the query.

In some embodiments, the rules modeler is further configured to perform a materialization of the first plurality of RDF triples to add new rules to the first plurality of rules.

In some embodiments, the travel schedule generation system further includes a user interface configured to provide (a) the plurality of rules that govern the travel schedule, or (b) the information about one or more users, or both (a) and (b).

In some embodiments, the plurality of rules that govern the travel schedule include one or more entry or exit requirements for one or more destinations. In some embodiments, the information about the one or more users includes one or more of a user's name, date of birth, passport details, one or more vaccinations, and one or more destinations.

In some embodiments, the plurality of rules are encoded as the first plurality of resource description framework (RDF) triples based on a predefined ontology. In some embodiments, the predefined ontology defines relationships between a plurality of terms representing a travel scheduling domain.

In some embodiments, the generated travel schedule defines a journey having one or more journey legs, and the generated travel schedule includes personalized information for each user of the one or more users for each journey leg of the one or more journey legs.

In some embodiments, the one or more rules of the plurality of rules are obtained from an external database, and the rules modeler accesses the external database and updates the one or more rules of the plurality of rules prior to each execution of the schedule generator.

In some embodiments, the schedule generator generates one or more prepopulated forms with relevant information from the generated travel schedule.

In some embodiments, the method of generating a travel schedule, executed by a programmed processor comprises receiving a plurality of rules that govern the travel schedule; encoding the received plurality of rules as a first plurality of resource description framework (RDF) triples; generating a knowledge graph using the first plurality of RDF triples; receiving information about one or more users; encoding the received information about the one or more users as a second plurality of RDF triples; generating a query using the second plurality of RDF triples; and generating a travel schedule by performing semantic reasoning on the knowledge graph using the query.

In some embodiments, the method of generating a travel schedule, executed by a programmed processor, is stored on a non-transitory computer readable storage medium.

According to some embodiments, a computer program product includes program code portions for performing the steps of any or all of each of methods described herein, when the computer program product is executed by a computing device. Each of any or all of such computer program products may be stored on one or more computer readable storage mediums.

Any of the features of all or part of any or all of the methods and processes discussed herein may be combined with any of the other features of all or part of any or all of the methods and processes discussed herein. In addition, a computer program product may be provided that comprises program code portions for performing some or all of any or all of the methods and processes and associated features thereof described herein, when the computer program product is executed by a computer or other computing device or device system. Such a computer program product may be stored on one or more computer-readable storage mediums, also referred to as one or more computer-readable data storage mediums.

### BRIEF DESCRIPTION OF THE DRAWINGS

It is to be understood that the attached drawings are for purposes of illustrating aspects of various embodiments and may include elements that are not to scale. It is noted that like reference characters in different figures refer to the same objects.

FIG. 1 shows an example of a computing device system in accordance with an embodiment of the invention;

FIG. 2 shows another example of a computing device system in accordance with an embodiment of the invention;

FIG. 3 shows a block diagram illustrating an automatic schedule generation system in accordance with an embodiment of the invention;

FIG. 4 shows an exemplar home screen of a graphical user interface of the automatic schedule generation system in accordance with an embodiment of the invention;

FIG. 5A shows an exemplar traveler profile screen of a graphical user interface of the automatic schedule generation system in accordance with an embodiment of the invention;

FIG. 5B shows an exemplar traveler profile entry screen of a graphical user interface of the automatic schedule generation system in accordance with an embodiment of the invention;

FIG. 5C shows an exemplar vaccine information entry screen of a graphical user interface of the automatic schedule generation system in accordance with an embodiment of the invention;

FIG. 6A shows an exemplar journey screen of a graphical user interface of the automatic schedule generation system in accordance with an embodiment of the invention;

FIG. 6B shows an exemplar journey leg screen of a graphical user interface of the automatic schedule generation system in accordance with an embodiment of the invention;

FIG. 6C shows an exemplar journey leg entry screen of a graphical user interface of the automatic schedule generation system in accordance with an embodiment of the invention;

FIG. 7A shows an exemplar calendar screen of a graphical user interface of the automatic schedule generation system in accordance with an embodiment of the invention;

FIG. 7B shows another exemplar calendar screen of a graphical user interface of the automatic schedule generation system in accordance with an embodiment of the invention;

FIG. 8 shows an exemplar ontology for the automatic schedule generation system in accordance with an embodiment of the invention;

FIG. 9 shows a flowchart for a method of automatically generating a trip schedule in accordance with an embodiment of the invention; and

FIG. 10 shows a flowchart for a method of automatically generating a knowledge graph of COVID-19 travel rules in accordance with an embodiment of the invention.

### DETAILED DESCRIPTION OF THE INVENTION

The present invention provides various systems and methods for modelling travel rules and regulations as machine understandable and self-aware semantic graphs and automating schedule generation and trip planning with symbolic reasoning. It should be noted that the invention is not limited to these or any other examples provided herein, which are referred to for purposes of illustration only.

In this regard, in the descriptions herein, certain specific details are set forth in order to provide a thorough understanding of various embodiments of the invention. However, one skilled in the art will understand that the invention may be practiced at a more general level without one or more of these details. In other instances, well-known structures have not been shown or described in detail to avoid unnecessarily obscuring descriptions of various embodiments of the invention.

Any reference throughout this specification to “one embodiment”, “an embodiment”, “an example embodiment”, “an illustrated embodiment”, “a particular embodiment”, “some embodiments” and the like means that a particular feature, structure or characteristic described in connection with the embodiment is included in at least one embodiment. Thus, any appearance of the phrase “in one embodiment”, “in an embodiment”, “in an example embodiment”, “in this illustrated embodiment”, “in this particular embodiment”, “some embodiments” or the like in this specification is not necessarily all referring to one embodiment or a same embodiment. Furthermore, the particular features, structures or characteristics of different embodiments may be combined in any suitable manner to form one or more other embodiments.

Unless otherwise explicitly noted or required by context, the word “or” is used in this disclosure in a non-exclusive sense. In addition, unless otherwise explicitly noted or required by context, the word “set” is intended to mean one or more. For example, the phrase, “a set of objects” means one or more of the objects.

In the following description, some embodiments of the present invention may be implemented at least in part by a data processing device system configured by a software program. Such a program may equivalently be implemented as multiple programs, and some or all of such software program(s) may be equivalently constructed in hardware. Further, the phrase “at least” is or may be used herein at times merely to emphasize the possibility that other elements may exist beside those explicitly listed. However, unless otherwise explicitly noted (such as by the use of the term “only”) or required by context, non-usage herein of the phrase “at least” nonetheless includes the possibility that other elements may exist besides those explicitly listed. For example, the phrase, ‘based at least on A’ includes A as well as the possibility of one or more other additional elements besides A. In the same manner, the phrase, ‘based on A’ includes A, as well as the possibility of one or more other additional elements besides A. However, the phrase, ‘based only on A’ includes only A. Similarly, the phrase ‘configured at least to A’ includes a configuration to perform A, as well as the possibility of one or more other additional actions besides A. In the same manner, the phrase ‘configured to A’ includes a configuration to perform A, as well as the possibility of one or more other additional actions besides A. However, the phrase, ‘configured only to A’ means a configuration to perform only A.

The word “device”, the word “machine”, the word “system”, and the phrase “device system” all are intended to include one or more physical devices or sub-devices (e.g., pieces of equipment) that interact to perform one or more functions, regardless of whether such devices or sub-devices are located within a same housing or different housings. However, it may be explicitly specified according to various embodiments that a device or machine or device system resides entirely within a same housing to exclude embodiments where the respective device, machine, system, or device system resides across different housings. The word “device” may equivalently be referred to as a “device system” in some embodiments.

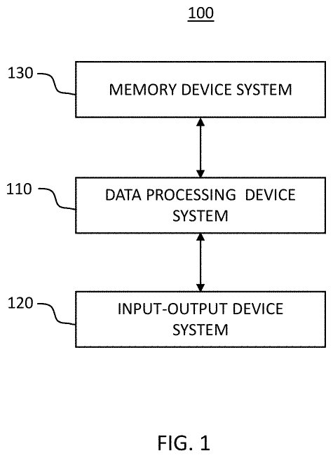

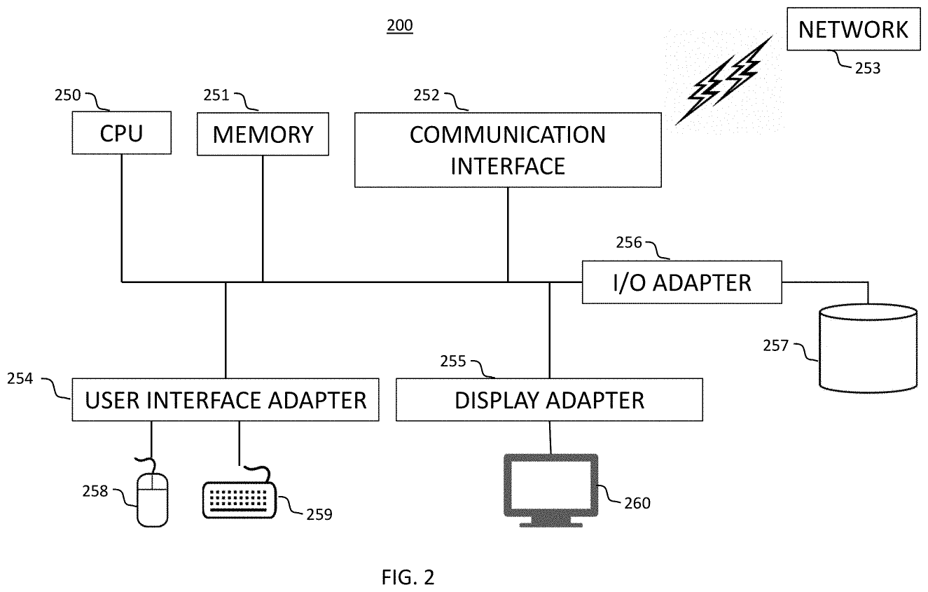

The term “program” in this disclosure should be interpreted to include one or more programs including a set of instructions or modules that may be executed by one or more components in a system, such as a controller system or data processing device system, in order to cause the system to perform one or more operations. The set of instructions or modules may be stored by any kind of memory device, such as those described subsequently with respect to the memory device system 130, 251, or both, shown in FIGS. 1 and 2, respectively. In addition, this disclosure may describe or similarly describe that the instructions or modules of a program are configured to cause the performance of an action. The phrase “configured to” in this context is intended to include at least (a) instructions or modules that are presently in a form executable by one or more data processing devices to cause performance of the action (e.g., in the case where the instructions or modules are in a compiled and unencrypted form ready for execution), and (b) instructions or modules that are presently in a form not executable by the one or more data processing devices, but could be translated into the form executable by the one or more data processing devices to cause performance of the action (e.g., in the case where the instructions or modules are encrypted in a non-executable manner, but through performance of a decryption process, would be translated into a form ready for execution). Such descriptions should be deemed to be equivalent to describing that the instructions or modules are configured to cause the performance of the action. The word “module” may be defined as a set of instructions. The word “program” and the word “module” may each be interpreted to include multiple sub-programs or multiple sub-modules, respectively. In this regard, reference to a program or a module may be considered to refer to multiple programs or multiple modules.

Further, it is understood that information or data may be operated upon, manipulated, or converted into different forms as it moves through various devices or workflows. In this regard, unless otherwise explicitly noted or required by context, it is intended that any reference herein to information or data includes modifications to that information or data. For example, “data X” may be encrypted for transmission, and a reference to “data X” is intended to include both its encrypted and unencrypted forms, unless otherwise required or indicated by context. Further, the phrase “graphical representation” used herein is intended to include a visual representation presented via a display device system and may include computer-generated text, graphics, animations, or one or more combinations thereof, which may include one or more visual representations originally generated, at least in part, by an image-capture device.

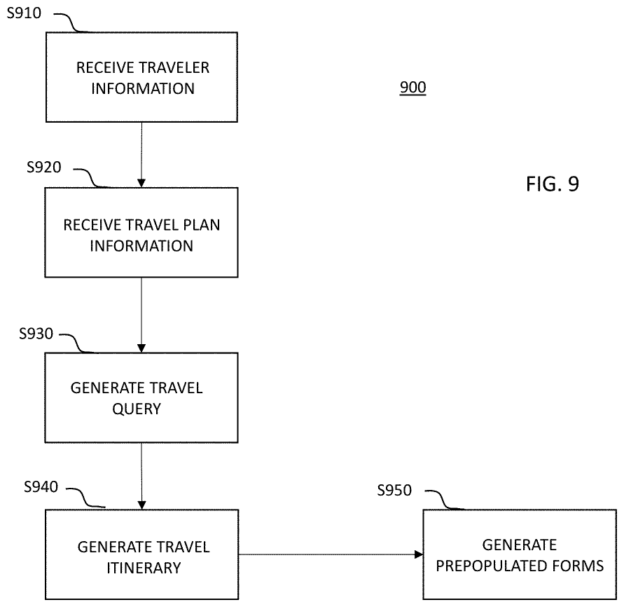

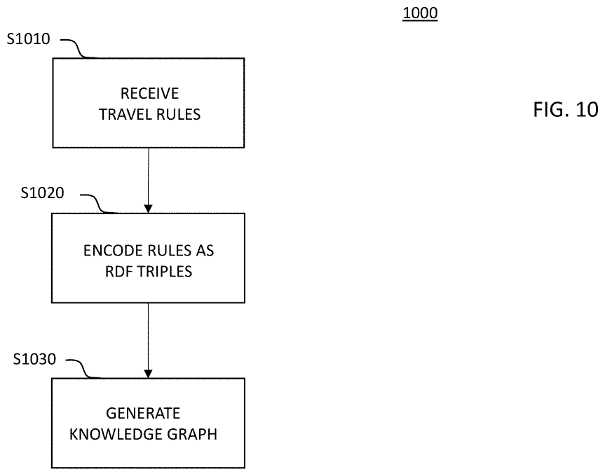

Further still, example methods are described herein with respect to FIGS. 9 and 10. Such figures are described to include blocks associated with computer-executable instructions. It should be noted that the respective instructions associated with any such blocks herein need not be separate instructions and may be combined with other instructions to form a combined instruction set. The same set of instructions may be associated with more than one block. In this regard, the block arrangement shown in method FIGS. 9 and 10 herein is not limited to an actual structure of any program or set of instructions or required ordering of method tasks, and such method FIGS. 9 and 10, according to some embodiments, merely illustrate the tasks that instructions are configured to perform, for example upon execution by a data processing device system in conjunction with interactions with one or more other devices or device systems.

FIG. 1 schematically illustrates a system 100 according to some embodiments. In some embodiments, the system 100 may be a computing device 200 (as shown in FIG. 2). In some embodiments, the system 100 includes a data processing device system 110, an input-output device system 120, and a processor-accessible memory device system 130. The processor-accessible memory device system 130 and the input-output device system 120 are communicatively connected to the data processing device system 110.

The data processing device system 110 includes one or more data processing devices that implement or execute, in conjunction with other devices, such as one or more of those in the system 100, control programs associated with some of the various embodiments. Each of the phrases “data processing device”, “data processor”, “processor”, and “computer” is intended to include any data processing device, such as a central processing unit (“CPU”), a desktop computer, a laptop computer, a mainframe computer, a tablet computer, a personal digital assistant, a cellular phone, and any other device configured to process data, manage data, or handle data, whether implemented with electrical, magnetic, optical, biological components, or other.

The memory device system 130 includes one or more processor-accessible memory devices configured to store information, including the information needed to execute the control programs associated with some of the various embodiments. The memory device system 130 may be a distributed processor-accessible memory device system including multiple processor-accessible memory devices communicatively connected to the data processing device system 110 via a plurality of computers and/or devices. On the other hand, the memory device system 130 need not be a distributed processor-accessible memory system and, consequently, may include one or more processor-accessible memory devices located within a single data processing device.

Each of the phrases “processor-accessible memory” and “processor-accessible memory device” is intended to include any processor-accessible data storage device, whether volatile or nonvolatile, electronic, magnetic, optical, or otherwise, including but not limited to, registers, floppy disks, hard disks, Compact Discs, DVDs, flash memories, ROMs (Read-Only Memory), and RAMs (Random Access Memory). In some embodiments, each of the phrases “processor-accessible memory” and “processor-accessible memory device” is intended to include a non-transitory computer-readable storage medium. In some embodiments, the memory device system 130 can be considered a non-transitory computer-readable storage medium system.

The phrase “communicatively connected” is intended to include any type of connection, whether wired or wireless, between devices, data processors, or programs in which data may be communicated. Further, the phrase “communicatively connected” is intended to include a connection between devices or programs within a single data processor, a connection between devices or programs located in different data processors, and a connection between devices not located in data processors at all. In this regard, although the memory device system 130 is shown separately from the data processing device system 110 and the input-output device system 120, one skilled in the art will appreciate that the memory device system 130 may be located completely or partially within the data processing device system 110 or the input-output device system 120. Further in this regard, although the input-output device system 120 is shown separately from the data processing device system 110 and the memory device system 130, one skilled in the art will appreciate that such system may be located completely or partially within the data processing system 110 or the memory device system 130, depending upon the contents of the input-output device system 120. Further still, the data processing device system 110, the input-output device system 120, and the memory device system 130 may be located entirely within the same device or housing or may be separately located, but communicatively connected, among different devices or housings. In the case where the data processing device system 110, the input-output device system 120, and the memory device system 130 are located within the same device, the system 100 of FIG. 1 can be implemented by a single application-specific integrated circuit (ASIC) in some embodiments.

The input-output device system 120 may include a mouse, a keyboard, a touch screen, another computer, or any device or combination of devices from which a desired selection, desired information, instructions, or any other data is input to the data processing device system 110. The input-output device system 120 may include any suitable interface for receiving information, instructions or any data from other devices and systems described in various ones of the embodiments.

The input-output device system 120 also may include an image generating device system, a display device system, a speaker device system, a processor-accessible memory device system, or any device or combination of devices to which information, instructions, or any other data is output from the data processing device system 110. In this regard, if the input-output device system 120 includes a processor-accessible memory device, such memory device may or may not form part or all of the memory device system 130. The input-output device system 120 may include any suitable interface for outputting information, instructions or data to other devices and systems described in various ones of the embodiments. In this regard, the input-output device system may include various other devices or systems described in various embodiments.

FIG. 2 shows an example of a computing device system 200, according to some embodiments. The computing device system 200 may include a processor 250, corresponding to the data processing device system 110 of FIG. 1, in some embodiments. The memory 251, input/output (I/O) adapter 256, and non-transitory storage medium 257 may correspond to the memory device system 130 of FIG. 1, according to some embodiments. The user interface adapter 254, mouse 258, keyboard 259, display adapter 255, and display 260 may correspond to the input-output device system 120 of FIG. 1, according to some embodiments. The computing device 200 may also include a communication interface 252 that connects to a network 253 for communicating with other computing devices 200.

Various methods 900, 1000 may be performed by way of associated computer-executable instructions according to some example embodiments. In various example embodiments, a memory device system (e.g., memory device system 130) is communicatively connected to a data processing device system (e.g., data processing device systems 110, otherwise stated herein as “e.g., 110”) and stores a program executable by the data processing device system to cause the data processing device system to execute various embodiments of methods 900, 1000. In these various embodiments, the program may include instructions configured to perform, or cause to be performed, various ones of the instructions associated with execution of various embodiments of methods 900, 1000. In some embodiments, methods 900, 1000 may include a subset of the associated blocks or additional blocks than those shown in FIGS. 9 and 10. In some embodiments, methods 900, 1000 may include a different sequence indicated between various ones of the associated blocks shown in FIGS. 9 and 10.

In some embodiments of the invention, travel rules and regulations may be represented in an RDF triplestore graph (knowledge graph) as triples, and the travel schedule can be generated by querying the knowledge graph based on traveler profile information. The RDF triplestore is a type of graph database that stores semantic facts. RDF, which stands for Resource Description Framework, is a model for data publishing and interchange on the Web standardized by W3C. Being a graph database, triplestores store data as a network of objects with materialized links between them. This makes RDF triplestores the preferred choice for managing highly interconnected data. Triplestores are more flexible and less costly than a relational database, for example.

The RDF database, often called a semantic graph database or knowledge graph, is also capable of handling powerful semantic queries and of using inference for uncovering new information out of the existing relations. The RDF triplestore is a type of graph database that stores semantic facts. RDF, which stands for Resource Description Framework, is a model for data publishing and interchange on the Web standardized by W3C.

Being a graph database, triplestores store data as a network of objects with materialized links between them. This makes RDF triplestores the preferred choice for managing highly interconnected data. Triplestores are more flexible and less costly than a relational database, for example.

The RDF database is also capable of handling powerful semantic queries and using inference for uncovering new information out of the existing relations. In contrast to other types of graph databases, RDF triplestore engines support optional schema models, called ontologies. Ontologies allow for a formal description of the data. They specify both object classes and relationship properties, and their hierarchical order.

Ontologies are semantic data models that define the types of things that exist in a domain and the properties that can be used to describe them. Ontologies are generalized data models, meaning that they only model general types of things that share certain properties, but don't include information about specific entities in the domain. For example, instead of describing France, a specific country and all of travel rules and regulations, the ontology should focus on the general concept of countries, trying to capture characteristics that most/many countries might have. Doing this allows us to reuse the ontology to describe additional countries in a semantic graph in the future.

There are three main components to an ontology. Classes refer to the distinct types of entities that exist in the domain being modeled. Relationships refer to properties that connect two classes. Attributes refer to properties that describe an individual class.

The data in an RDF triplestore is stored in three linked data pieces, subject->predicate->object, which are called a triple, hence the name triplestores. The triples are also referred to as ‘statements’ or ‘RDF statements’. The subject->predicate->object format is able to take any subject and connect it to any other object by using the predicate (verb) to show the type of relationship existing between the subject and the object. When a set of triples are joined together, they form a natural graph, where the predicates are interpreted as edges, and the subjects and objects are the nodes of the graph.

RDF triplestores handle huge amounts of data, which improves the knowledge discovery and analytics capabilities of the modeled domain. Further, triplestores are able to infer implicit facts out of the explicit statements. Inferencing relationships out of the original data, with the help of a semantic graph database, turns information into knowledge. This allows systems to uncover hidden relationships across all their data.

Triplestores also facilitate many text analytics techniques such as extracting information from unstructured data and enriching content. By ‘learning’ the meaning as well as the context in which entities (nodes in the graph) are used, machine learning algorithms can classify entities and disambiguate between them (for example, whether “Paris” in a text refers to “Paris, France”, or “Paris, Texas”, or “Paris Hilton”). In many semantic reasoning domains a tremendous amount of statements (expressed as RDF triples) might be true but, in a given domain, only a small number of statements is known to be true or can be inferred to be true. It thus makes sense to also estimate the truth values of statements by exploring regularities in the semantic reasoning data with machine learning. At a high level, machine learning in RDF triplestores involves learning a probabilistic model which introduces probabilistic nodes in the knowledge graph. The states of the probabilistic nodes reflect the truth value of the corresponding statements. A data matrix is derived from the RDF triplestore for model training. This data matrix is typically high-dimensional and sparse, and may have missing information (knowledge about the domain that is not encoded in the RDF triplestore). Conventional matrix completion approaches, well known in the art, may be used for estimating the missing information in the data matrix. Since the data matrix is typically independent or only weakly dependent on the overall size of the knowledge in the domain, training time is essentially independent of the overall size of the domain.

In some embodiments of the invention, machine learning on the RDF triplestore is performed using materialization of the knowledge graph. Materialization is one way for a knowledge graph to perform its reasoning. When given some data and some rules, the reasoning engine will create new data and put it in the RDF datastore, adding information to the dataset itself. This approach is different from backward chaining, where no data is created but queries are instead rewritten internally, providing information at a level removed from the data layer.

U.S. Pat. No. 10,817,467 describes a method of providing a materialization of a set of logical rules on a logical database (RDF triplestore) comprising a set of logical facts (RDF triples). The RDF triplestore is represented using a logical database including a set of logical facts and at least one index that includes a pointer for locating a logical fact (RDF triple) in the set of logical facts, and a plurality of parallel processing threads. Each of the plurality of parallel processing threads has an associated reserved area in the logical database for adding a new logical fact to the set of logical facts. Each of the plurality of parallel processing threads of the computer system performs steps comprising 1) retrieving a logical fact, which has not previously been retrieved by any thread, from the set of logical facts; 2) applying at least one logical rule from the set of logical rules to the retrieved logical fact and any of the logical facts previously retrieved by any thread to derive a new logical fact; adding the new logical fact to the set of logical facts and updating the at least one index; and repeating steps 1 to 3 of the method while there are logical facts in the set of logical facts that have not previously been retrieved by any thread.

Apart from defining relationships, RDF triples also allow links between databases with structured data and documents that contain unstructured, free-flowing text. In this way, RDF triplestores connect entities from databases to documents that mention these entities.

The type of graph is not limited to RDF and could also be a property graph or hypergraph, among other examples. Often RDF triplestores are criticized because they don't allow for descriptions or properties to be attached to the edges in the graph. This is perceived by some as a disadvantage compared to property graphs. However, this concern can be addressed by using RDF-Star (abbreviated RDF*) triplestores, which allow one to attach metadata to the edges in the graph.

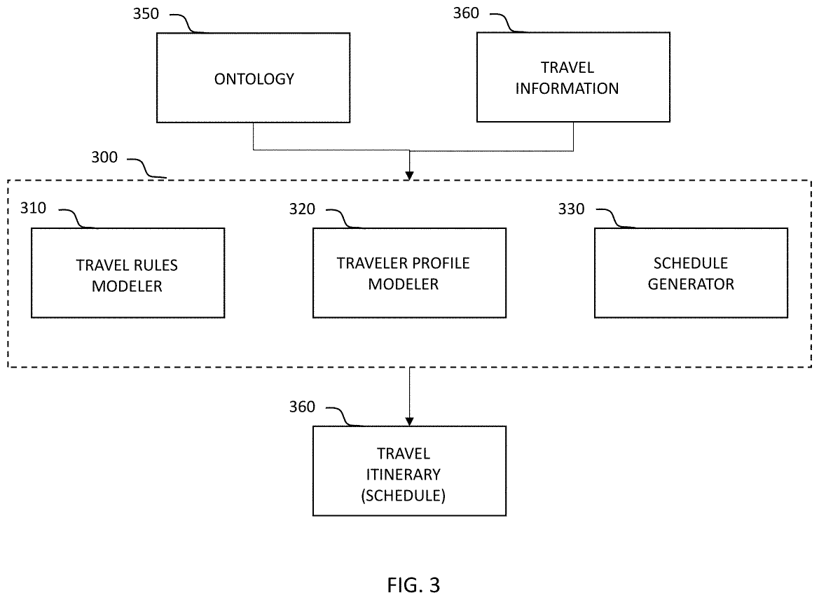

FIG. 3 shows an automatic schedule generation system 300 in accordance with an embodiment of the invention. In some embodiments of the invention, the schedule generation system 300 includes a travel rules modeler 310, a traveler profile modeler 320, and a schedule generator 330. In some embodiments of the invention, the schedule generation system 300 may be configured to, via the stored program, receive travel information 360. The travel information 360 may include information on the origin and destination(s) for a travel party of one or more travelers, and information about the one or more travelers. The destination(s) included in the travel information 360 govern a plurality of travel rules and regulations governing entry and exit requirements for each destination. In some embodiments of the invention, the travel rules modeler 310 may be configured to encode the plurality of travel rules as RDF triples. In some embodiments of the invention, the traveler profile modeler 320 may be configured to encode the information about the one or more travelers as RDF triples. The plurality of travel rules and the information about the travelers, encoded as RDF triples, may be modeled as a knowledge graph representing domain knowledge about COVID-19 travel restrictions.

In some embodiments of the invention, the travel information 360 may be provided to the schedule generation system 300 by a user via a graphical user interface 400. The user may be a travel planner or the traveler themselves.

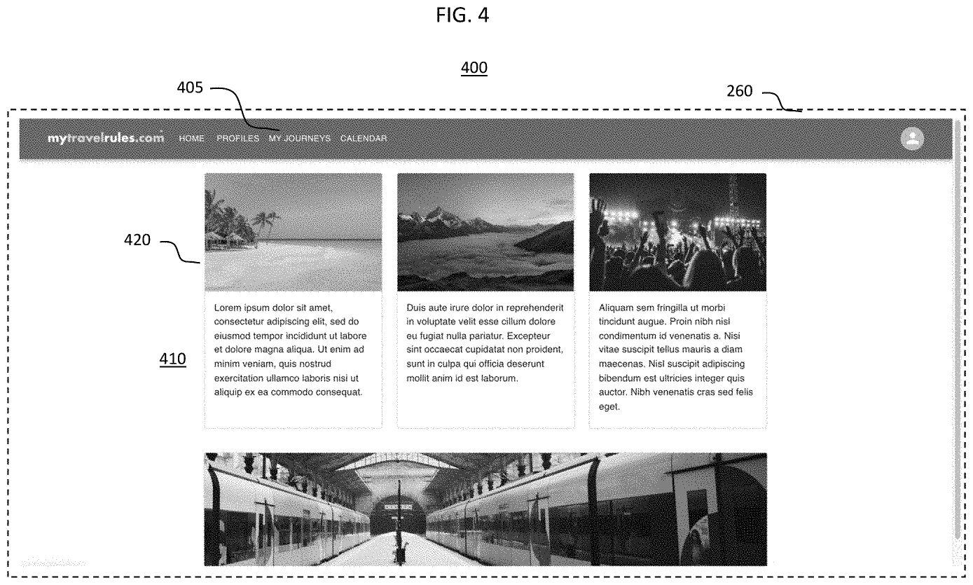

FIG. 4 shows an exemplar user interface screen of the graphical user interface 400 displayed on a display 260, according to some embodiments of the invention. The graphical user interface 400 includes a menu bar 405 that permits the user to switch between different user interface screens. In some embodiments, the user interface screens include a home screen 410, a traveler profile screen 510, a journey screen 610, and calendar screens 710, 720, corresponding to selectable options included in the menu bar 405.

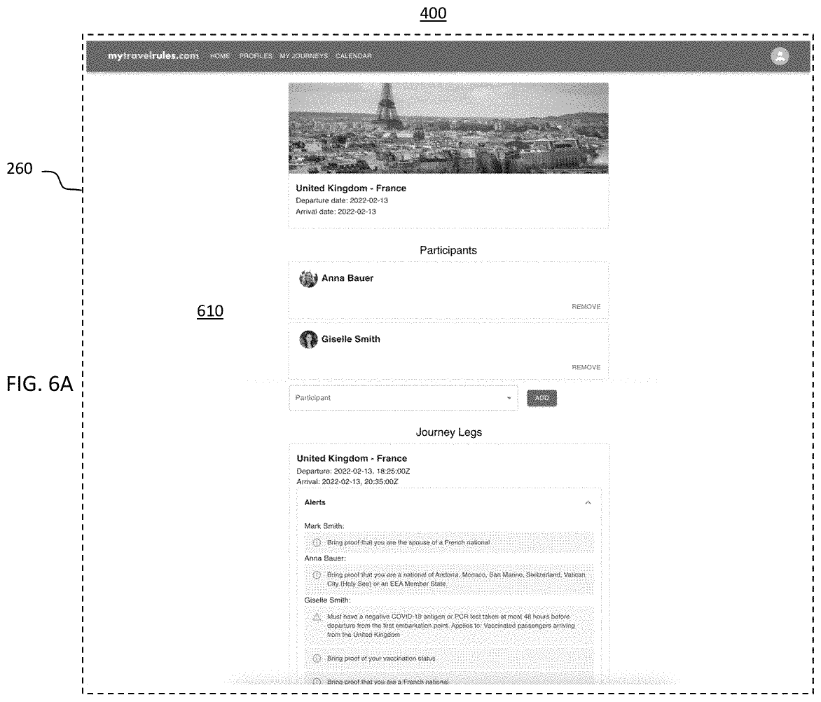

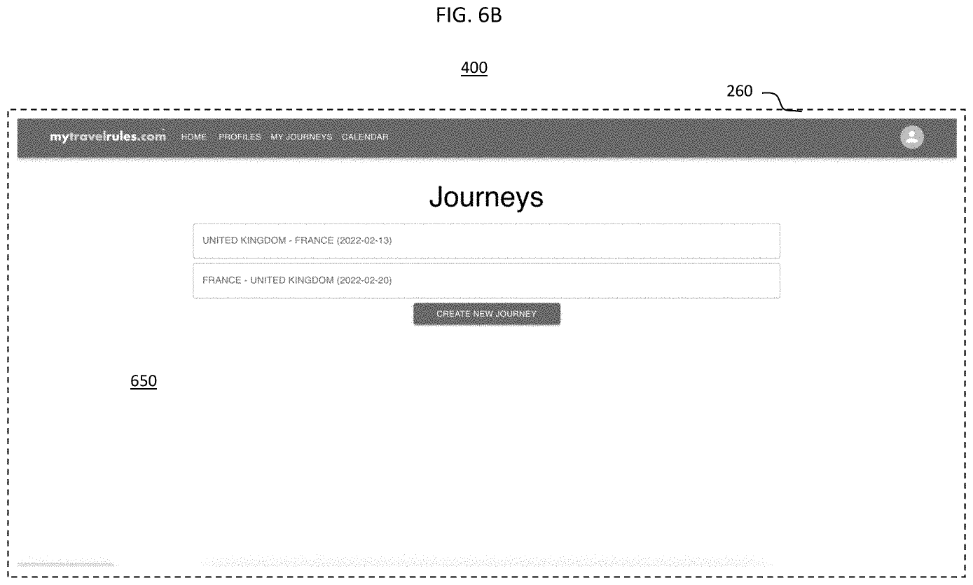

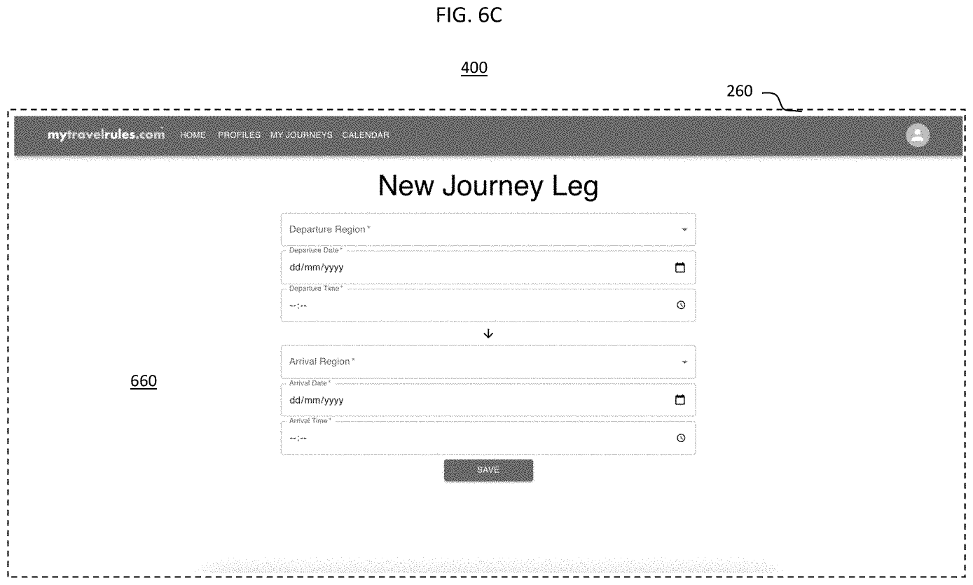

The exemplar user interface screen shown in FIG. 4 corresponds to a home screen 410 of the graphical user interface 400. The home screen 410 includes one or more icons 420 representing one or more trips (journeys) scheduled and planned using the schedule generation system 300. In some embodiments, the user may select one of the icons 420 to display a journey screen 610 (see FIG. 6) of the graphical user interface 400.

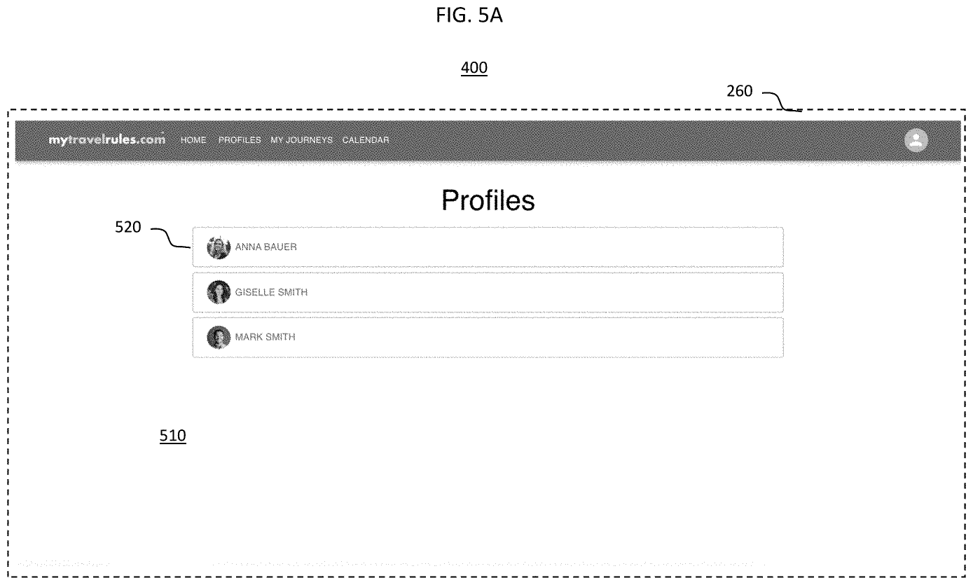

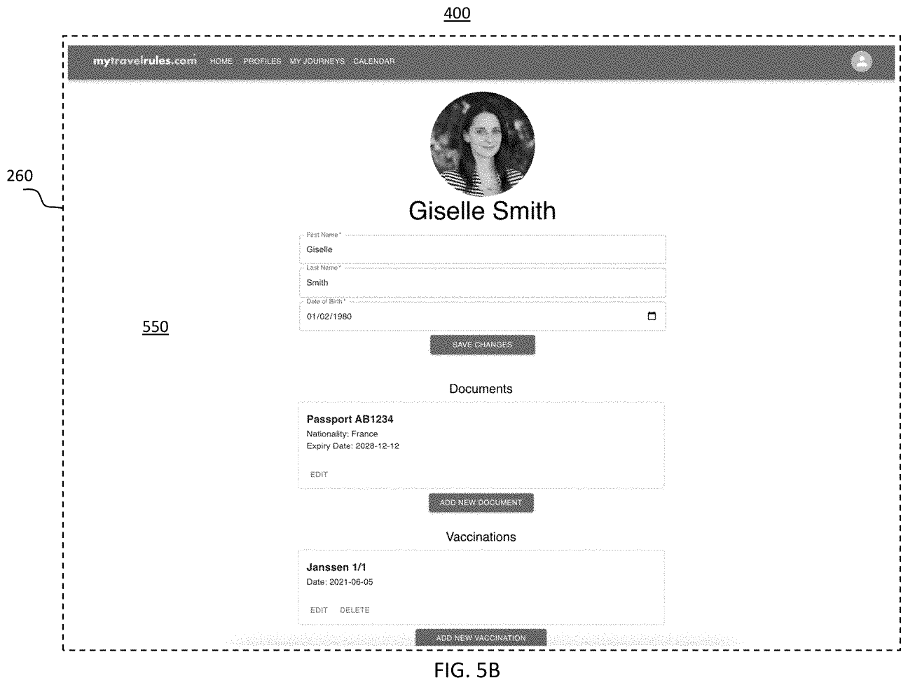

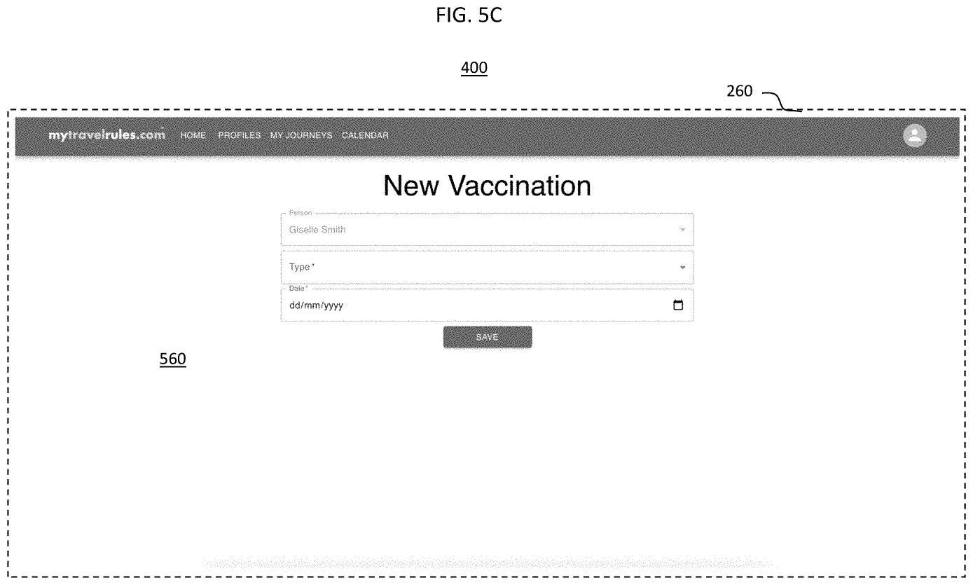

FIG. 5A shows an exemplar traveler profile screen 510 of the graphical user interface 400 according to some embodiments of the invention. The traveler profile screen 510 includes travel profile information for one or more travelers 520 in the travel party. Selecting a traveler 520 switches the user interface screen of the graphical user interface to a travel profile data entry screen 550, as shown in FIG. 5B. The travel profile data entry screen 550 permits the user to enter travel profile information for each traveler. In some embodiments, the travel profile information may include the first and last name of the traveler, date of birth, passport information including document number, nationality, and expiration date, and vaccination information including vaccine type, dose number, and date of vaccination. FIG. 5C shows as exemplar vaccine information data entry screen 560 that permits the user to enter the vaccination information for a traveler.

In an alternate embodiment, the schedule generation system 300 may use the traveler profile information entered in the travel profile data entry screen 550 to access a national vaccination database, which stores verified vaccination information, to automatically obtain the vaccination information for the traveler.

FIG. 6A shows an exemplar journey screen 610 of the graphical user interface 400 according to some embodiments of the invention. The journey screen 610 displays travel details for a selected trip, travelers (participants), and detailed information on each leg of the journey. The detailed information on the journey leg includes personalized information for each traveler, based on their traveler profile. The personalized information includes alerts for proof of nationality and vaccination status that must be carried by the traveler, and any applicable COVID-19 testing requirements.

The user may enter a new leg for the journey using the journey leg entry screens 650 and 660 shown in FIGS. 6B and 6C, respectively.

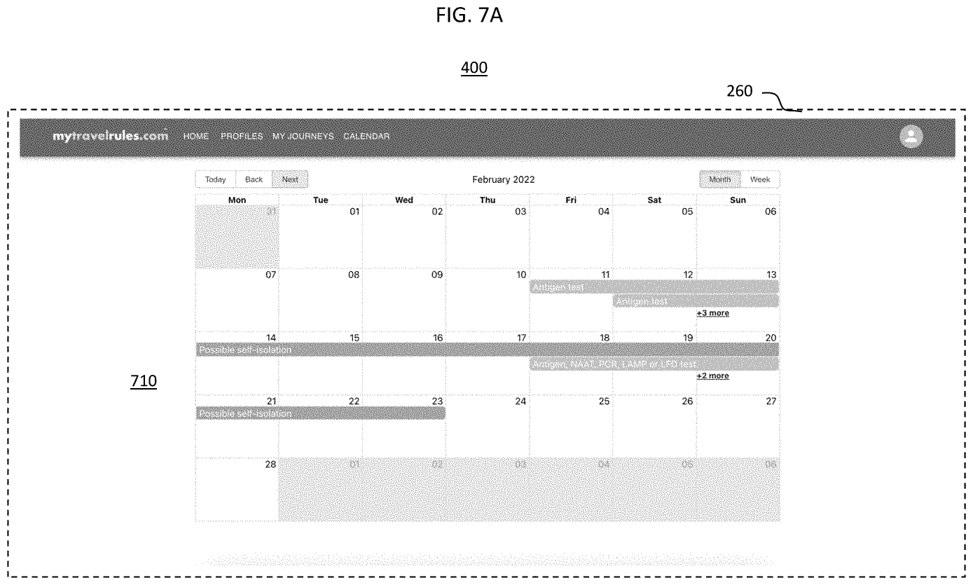

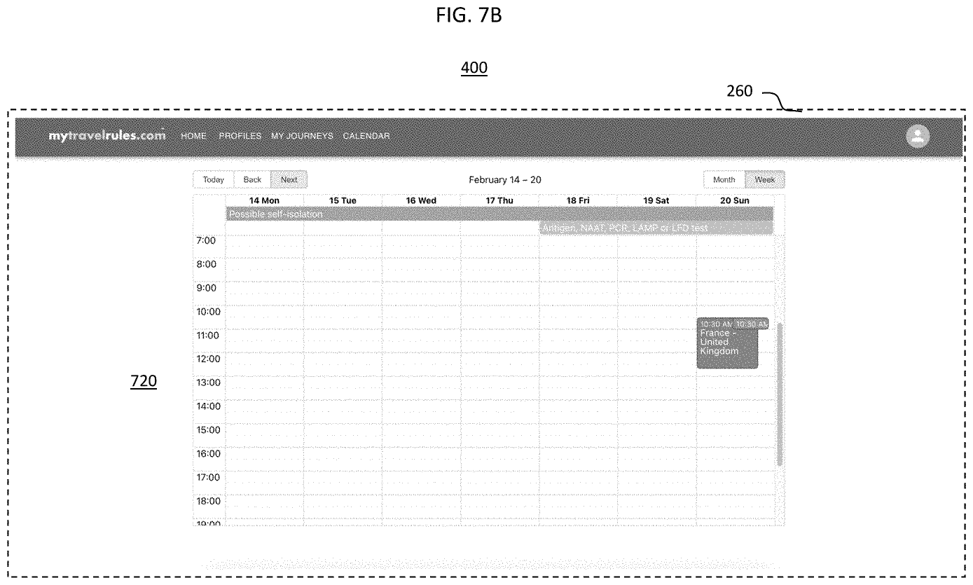

FIGS. 7A and 7B show an exemplar calendar screens 710, 720 of the graphical user interface 400 according to some embodiments of the invention. The calendar screen 710 displays travel details for a selected trip in a monthly view, including information on when and what types of COVID-19 testing needs to be performed and potential isolation periods; travelers (participants), and detailed information on each leg of the journey. The calendar screen 720 displays more detailed information for the selected trip in a weekly view, along with specific time (in hours and minutes) for various actions that may need to be performed.

In some embodiments, the schedule generation system 300 may include a domain modeling stage in which a user (travel planner) encodes travel rules for specific countries based on a defined ontology.

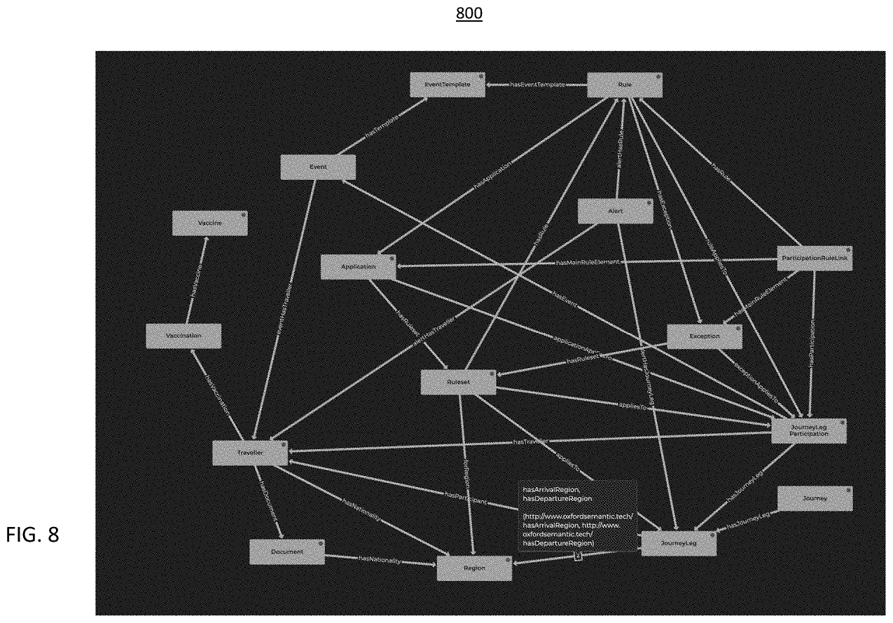

FIG. 8 shows an exemplar ontology 800 for the schedule generation system 300. The ontology 800 defines relationships between various entities in the domain. For example, in the exemplar ontology 800 shown in FIG. 8, Travellers have Documents and Vaccinations. Documents have Regions (their nationality), as well as expiry dates and numbers. Countries are a subclass of Regions. Vaccinations have Vaccines (their type: Janssen, Pfizer, etc. and their administration dates and times (dateTimes)). A Journey has one or more legs (JourneyLegs). Each JourneyLeg has an origin (departureRegions) and destination (arrivalRegions) as well as departure and arrival dates and times (dateTimes). Each JourneyLeg has one or more Travellers as their participants, and for each pair of JourneyLeg and Traveller, a JourneyLegParticipation entity is created. Rulesets governing COVID-19 rules and regulations have start dates and times, defining the period when the Ruleset is active, and Regions for which they are valid. Rulesets contain Rules and Rules have Applications and Exceptions. Applications and Exceptions have various types with connections to :Regions, :Vaccines, dateTimes, durations etc. Whenever a Rule's Ruleset is applicable to a JourneyLegParticipation's destination Region, a ParticipationRuleLink is created. ParticipationRuleLinks have mainRuleElements, which can be Applications or Exceptions. Rules also have EventTemplates, which can have text and duration. Events have EventTemplates and Travellers, as well as a connection to JourneyLegParticipations. Alerts have Rules, Travellers and JourneyLegs, as well as text.

The travel rules are encoded as RDF triples and define the knowledge graph over which the semantic reasoning will be performed for schedule generation by the schedule generator 330. In some embodiments, the ontology is created and managed by a knowledge engineer, i.e. a person tasked with composing triples in the RDF triple store that reflect the travel rules implemented by each country. The function of the knowledge engineer is to ensure that the ontology is comprehensive, accurately reflects the real world, and operates correctly. Introducing and updating the travel rules for any given country is the function of a regional manager who is responsible for monitoring the travel rules for their region. When the knowledge engineer or the regional manager wish to create or update a new set of travel restrictions, they do so by selecting from a series of menus and submenus. For example, if France introduces a red list, the regional manager will select the country profile for France, then select the red list and (a) select the countries on the red list from a submenu and (b) select from another submenu the exceptions that apply (for example, a nationality exception and a residence exception). For the nationality exception, the regional manager will further select the nationalities which qualify for the exception, for example, French and European Union. (Note that as the ontology already includes the fact that the EU has 27 member states, a traveler with a Spanish passport will be treated as satisfying this exception.) The ontology may reflect the state of the rules as of a particular date, encoding the travel restrictions prevalent at that time. If the ontology is highly complex, it may prove to be sufficient for future circumstances. If, however, an entirely new concept is introduced, the ontology can be updated by the knowledge engineer.

There are various factors that contribute to the complexity of the ontology. For example, every country has its own rules, definitions, and exceptions. Each country may have its own “Red List” of countries from which travel is prohibited. Each country may define “days” differently; for example, either as a standard day that begins as midnight, or as a 24-hr period preceding the time of entry. Each country may have different vaccines that they accept, and different definitions of a valid COVID-19 test (what test, administered by whom, and when),

Each traveler also has a unique set of attributes that define what sets of rules apply to them. For example, vaccination history (what type, when, and where administered), age, nationality, residency status, and recent travel history can affect what rules apply. Each itinerary may also have different variables that impact the set of applicable rules—for example, other travelers in the travel party and their sets of attributes, origins and destinations for each traveler and each leg of the journey, the purpose of travel, the routing if visiting more that one country, and dates and times for departures and arrivals for each leg of the journey.

Added complexity is generated by the dynamic nature of the rules and regulations. They are not static but, rather, are often changed by each country to respond to changing conditions of COVID-19 transmission and incidence. Rule changes by countries of origin may impact the applicable rules for the destination countries. Vaccines that were previously considered valid may no longer be sufficient. Travel plans may be disrupted, changing the itinerary and forcing a different set of rules to apply. The knowledge graph needs to support all of this complexity by providing a flexible ontology can be updated to reflect changing circumstances, and allow for easy maintenance of the rules and traveler information stored as triples in the knowledge graph.

In an alternate embodiment, one or more governments may establish APIs by which their rules are automatically uploaded to the system and converted into a knowledge graph using the ontology.

In some embodiments of the invention, the schedule generation system 300 may be further configured to automatically generate the schedule (travel itinerary) by performing semantic reasoning on the knowledge graph that models the plurality of travel rules and the traveler information. In some embodiments, semantic reasoning may be performed using queries (such as SPARQL) based on one or more destinations for the one or more travelers in the travel party. The information on destinations may be provided to system 300 using the journey screen 610 of the graphical user interface 400.

SPARQL is a standard query language and protocol for RDF databases. SPARQL can efficiently extract information hidden in non-uniform data and stored in various formats and sources, such as RDF triplestores or knowledge graphs. A SPARQL query consists of a set of triple patterns in which each element (the subject, predicate and object) can be a variable (wildcard). Solutions to the variables are then found by matching the patterns in the query to triples in the knowledge graph. SPARQL navigates relationships in RDF graph data through graph pattern matching. In this process, simple patterns can be combined into more complex ones, which explore more elaborate relationships in the data encoded in the knowledge graph.

The relationships can be explored by using basic patterns, pattern joins, unions, by adding optional patterns that may extend the information about the found solutions, etc. In addition, property paths allow sequential composition (sequencing), parallel composition (alternatives), iterations (Kleene star), inversion, etc.

FIG. 9 shows a flowchart for a method 900 of generating a COVID-19 compliant trip itinerary according to some embodiments of the invention. In step S910, information about the traveler(s) in a travel party is received. In some embodiments, a graphical user interface 400 may be used by a user (travel planner) to input the profiles of each traveler. The user interface 400 uses the ontology 800 to define and capture the information required to query the knowledge graph. The knowledge graph may be generated, for example, using the method 100 described later in this specification. In step S920 information about the travel plans—origins and destinations, dates and times of travel—is received. As with traveler profile information, information about the travel plans may be input using the user interface 400.

In step S930, the traveler profile information and the information about the travel plans is used to automatically generate the travel query for extracting the applicable rules and regulations from the knowledge graph. In some embodiments, the travel query is encoded using SPARQL. In step S940, semantic reasoning is performed over the knowledge graph, using the travel query, to automatically generate the travel or trip itinerary. In some embodiments, the generated itinerary includes information about whether each traveler in the travel party is permitted to travel on each journey leg of the trip, what COVID-19 tests may be needed for each leg of the journey and when must the tests be taken, and other applicable alerts. In some embodiments, the trip itinerary may be displayed using the exemplar journey screen 610 or the calendar screens 710, 720 of the graphical user interface 400.

In some embodiments of the invention, in step S950, forms prepopulated with relevant information from the travel itinerary are generated for the traveler's signature and use.

The use of semantic reasoning to generate the travel itinerary provides significant advantages to the travelers over conventional methods. Semantic reasoning permits incremental reasoning, allowing the user to add new rules and regulations and quickly update the system to see how the changes impact their travel itinerary. For example, if the order of the itinerary is changed or some travelers are traveling together or separately or joining for some parts of the journey only, the semantic reasoning step S940 can be executed with different queries to consider different travel scenarios and options with very little effort. Once the itinerary is finalized, and the trip is under way, each traveler can opt to be notified of testing and other requirements as they travel. These may change during the trip, in which case the latest information, specific to each traveler can be made available in real time. Travelers can keep their profile on a mobile device and update it as they carry out tests, receive vaccinations, be diagnosed with COVID-19, or travel. If the traveler chooses to share their profile information with the system 300, the method 900 can be executed each time the travel profile information changes to generate a new COVID-19 compliant travel itinerary. If the traveler prefers, they can choose not to share their profile information with the system or off the device. In this case, the system can be deployed as a mobile application on the user's device. The mobile application will pull the rules to the device and not send the traveler's personal data to the cloud.

FIG. 10 shows a flowchart for a method 1000 of generating a knowledge graph that encodes the travel rules and regulations, according to some embodiments of the invention. in step S1010, the applicable set of travel rules and regulations for each origin and destination country in the journey are received. In step S1020, the travel rules are matched to the ontology 800 for encoding as RDF triples in a triple store. In step S1030, a knowledge graph that captures the complex interconnections between the encoded RDF triples is generated. The knowledge graph may combine generic travel rules defined in the ontology to generate advanced linkages and concepts. For example a generic rule may state that a person may not travel from an origin country (OC) to a destination country (DC) where the OC is a red list country for the DC. However, this rule may be modified by exceptions (nationality, purpose of visit, emergency travel authorization etc.), so long as other conditions of entry are satisfied.

In some embodiments, the knowledge engineer may use a graphical user interface, for example a web-based form, to upload the rules into the system using the ontology 800. The knowledge engineer identifies and p[populates core concepts by selecting which ones apply and then specifying the content. For example, the knowledge engineer may select the core concept “Red List Countries”, select the applicable countries from a drop down menu in the user interface, and then select any exceptions that may apply from a different drop down menu in the user interface.

Although the description above uses “COVID-19” as the exemplar disease, it should be noted that the methods and systems described herein are not limited to generating travel itineraries that are complaint with only COVID-19, but are readily applicable to any future event, such as another disease outbreak or pandemic, which may impose additional travel rules and restrictions. The methods and systems described herein are also readily adaptable to generating travel itineraries that are complaint with changing geopolitical situations and economic/social events.

In some embodiments of the invention, the methods 900 and 1000, executed by the programmed processor, are stored on a non-transitory computer readable storage medium.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of applicant's general inventive concept.

1. A travel schedule generation system comprising:
at least one memory configured to store a program; and
at least one processor communicatively connected to the at least one memory and configured to execute the stored program to function as:
a rules modeler configured to:
receive a plurality of rules that govern a travel schedule; and
encode the received plurality of rules as a first plurality of resource description framework (RDF) triples;
a profile modeler configured to:
receive information about one or more users; and
encode the received information about the one or more users as a second plurality of RDF triples; and
a schedule generator configured to:
generate a knowledge graph using the first plurality of RDF triples;
generate a query using the second plurality of RDF triples; and
generate the travel schedule by performing semantic reasoning on the knowledge graph using the query.

2. The travel schedule generation system according to claim 1, wherein the rules modeler is further configured to perform a materialization of the first plurality of RDF triples to add new rules to the first plurality of rules.

3. The travel schedule generation system according to claim 1, wherein the at least one processor is further configured to execute the stored program to function as a user interface configured to provide (a) the plurality of rules that govern the travel schedule, or (b) the information about one or more users, or both (a) and (b).

4. The travel schedule generation system according to claim 1, wherein plurality of rules that govern the travel schedule include one or more entry or exit requirements for one or more destinations.

5. The travel schedule generation system according to claim 1, wherein information about the one or more users includes one or more of a user's name, date of birth, passport details, one or more vaccinations, and one or more destinations.

6. The travel schedule generation system according to claim 1, wherein the plurality of rules are encoded as the first plurality of resource description framework (RDF) triples based on a predefined ontology.

7. The travel schedule generation system according to claim 6, wherein the predefined ontology defines relationships between a plurality of terms representing a travel scheduling domain.

8. The travel schedule generation system according to claim 1,
wherein the generated travel schedule defines a journey having one or more journey legs, and
wherein the generated travel schedule includes personalized information for each user of the one or more users for each journey leg of the one or more journey legs.

9. The travel schedule generation system according to claim 1,
wherein one or more rules of the plurality of rules are obtained from an external database, and
wherein the rules modeler is configured to access the external database and update the one or more rules of the plurality of rules prior to each execution of the schedule generator.

10. The travel schedule generation system according to claim 1, wherein the schedule generator is further configured to generate one or more prepopulated forms with relevant information from the generated travel schedule.

11. A method of generating a travel schedule, the method executable by a programmed processor, the method comprising:
receiving a plurality of rules that govern the travel schedule;
encoding the received plurality of rules as a first plurality of resource description framework (RDF) triples;
generating a knowledge graph using the first plurality of RDF triples;
receiving information about one or more users;
encoding the received information about the one or more users as a second plurality of RDF triples;
generating a query using the second plurality of RDF triples; and
generating a travel schedule by performing semantic reasoning on the knowledge graph using the query.

12. The method according to claim 11, further including performing a materialization of the first plurality of RDF triples to add new rules to the first plurality of rules.

13. The method according to claim 11, further including using a user interface to provide (a) the plurality of rules that govern the travel schedule, or (b) the information about one or more users, or both (a) and (b).

14. The method according to claim 11, wherein plurality of rules that govern the travel schedule include one or more entry or exit requirements for one or more destinations.

15. The method according to claim 11, wherein information about the one or more users includes one or more of a user's name, date of birth, passport details, one or more vaccinations, and one or more destinations.

16. The method according to claim 11, wherein the plurality of rules are encoded as the first plurality of resource description framework (RDF) triples based on a predefined ontology.

17. The method according to claim 16, wherein the predefined ontology defines relationships between a plurality of terms representing a travel scheduling domain.

18. The method according to claim 11,
wherein the generated travel schedule defines a journey having one or more journey legs, and
wherein the generated travel schedule includes personalized information for each user of the one or more users for each journey leg of the one or more journey legs.

19. The method according to claim 11,
wherein one or more rules of the plurality of rules are obtained from an external database, and
wherein the method further includes accessing the external database and update the one or more rules of the plurality of rules prior to generating the travel schedule.

20. The method according to claim 11, further including generating one or more prepopulated forms with relevant information from the generated travel schedule.
